(19) United States
(12) Patent Application Publication
(10) Pub. No.: US 2016/0049080 A1
(43) Pub. Date: Feb. 18, 2016

(54) SYSTEM AND METHOD FOR REDUCING IN-TRAIL PROCEDURE (ITP) REJECTION RATIO

(71) Applicant: HONEYWELL INTERNATIONAL INC., Morristown, NJ (US)

(72) Inventors: Suresh Bazawada, Bangalore Karnataka (IN); Mahesh Babu N, Bangalore Karnataka (IN); Vasudev Prakash Shanbhag, Bangalore Karnataka (IN)

(73) Assignee: HONEYWELL INTERNATIONAL INC., Morristown, NJ (US)

(21) Appl. No.: 14/458,882

(22) Filed: Aug. 13, 2014

(51) Int. Cl. G08G 5/00

(52) U.S. Cl. CPC G08G 5/0013; G08G 5/0039; G08G 5/0043

(57) ABSTRACT

A method and apparatus is provided for reducing the ITP rejection ratio. After identifying a reference aircraft, the ITP criteria associated with the reference aircraft is evaluated. If the ITP transition time overlaps with a maneuver time of the reference aircraft, the ITP request is not transmitted. The flight plan of the reference aircraft is analyzed to detect an upcoming reference aircraft maneuver.

### TECHNICAL FIELD

Embodiments of the subject matter described herein relate generally to avionics systems and methods for conducting in-trail procedures (ITP). More particularly, embodiments of the subject matter described herein relate to a system and method for reducing the number of In-Trail Procedure (ITP) rejections; i.e. the ITP rejection ratio.

### BACKGROUND

Modern flight deck instrumentation might include a traffic display that provides a two-dimensional representation of a host aircraft and neighboring aircraft. Such display systems typically provide a number of parameters and visual indicators that enable a pilot to form a quick mental picture of the vertical situation of the host aircraft. For example, such a system might include displays of an aircraft symbol, the aircraft altitude, the vertical flight plan, and terrain. In this manner, a member of the aircraft flight crew can obtain information related to the vertical situation of the aircraft relative to other aircraft with a simple glance at the display system.

An in-trail procedure (ITP) is a protocol that can be followed when an aircraft seeks to change its flight level to a new flight level in the presence of potentially blocking aircraft located at an intervening flight level. After the selection of the desired flight level and identification of reference aircraft, the onboard ITP system determines if the required ITP has been met by verifying that (1) the ITP distance is equal to or greater than 15 nautical miles (NM); (2) the ground speed differential between the host aircraft and reference aircraft is equal to or less than twenty knots; (3) the host aircraft has qualified ADS-B position data, velocity accuracy, and position integrity; (4) the host and reference aircraft are on a similar track; and (5) the reference aircraft has qualified ADS-B position data, velocity accuracy, and position integrity. If these criteria are satisfied, the host aircraft sends an ITP request to air traffic control (ATC). ATC then determines if this reference aircraft has been approved to change speed or flight level or is about to reach a point at which a significant track change will occur. If any such change is noted, the ITP request will be disallowed. That is, the conventional ITP evaluation criteria do not take flight path changes of the reference aircraft into consideration. Thus, even if the host aircraft sends an ITP request, it will be rejected by ATC if the flight path of the reference aircraft is expected to change in the near future. This increases the number of invalid ITP requests sent to ATC and the unnecessary waste of time on the part of the host aircraft waiting for an ATC response.

### SUMMARY

Described herein is method for reducing the number of rejections of ITP requests, comprising preventing transmission of an ITP request if the ITP transmission time overlaps with a reference aircraft maneuver time.

Also described herein is an avionics display system onboard a host aircraft that reduces ITP request rejection. The system comprises a first source of neighboring flight status data, a communication module coupled to the first source, a second source of airspace data in the vicinity of the flight plan, and a processor coupled to the data communication module and configured to (a) identify a reference aircraft, and (b) prevent transmission of an ITP request if a transmission time associated with the ITP request overlaps with a maneuver time of the reference.

Also provided is a method for reducing the ITP rejection ratio, comprising identifying a reference aircraft, evaluating the ITP criteria associated with the reference aircraft, and preventing transmission of an ITP request if the ITP transition time overlaps with a maneuver time of the reference aircraft.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram that illustrates the track associated with the flight path of an aircraft;

FIG. 2 is a diagram that illustrates the diverging tracks associated with two different aircraft;

FIG. 3 is a diagram that illustrates the converging tracks associated with two different aircraft;

FIG. 4 is a diagram that illustrates a basic ITP maneuver;

FIG. 5 is a diagram that illustrates the intersecting tracks associated with two different aircraft;

FIG. 6 is a diagram that illustrates the overlapping tracks associated with two different aircraft;

FIG. 7 is a block diagram of an exemplary embodiment of a flight deck display system;

FIG. 8 is a block diagram of a further exemplary embodiment of a flight deck display system; and

FIG. 9 is a flow chart of an exemplary embodiment of an ITP display process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to graphics and image processing, navigation, flight planning, aircraft controls, aircraft data communication systems, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Although not always required, the techniques and technologies described here are suitable for use by aircraft using an ITP in an oceanic (or other) track system. For example, the techniques and technologies presented here could be used in connection with the ITP as defined and explained in the Safety, Performance and Interoperability Requirements Document for the In-Trail Procedure in Oceanic Airspace (ATSA-ITP) Application, RTCA/DO-312, Jun. 19, 2008. For ease of understanding and clarity, the following description employs terminology that is consistent with that used in the RTCA/DO-312 document. Moreover, the relevant portions of the RTCA/DO-312 document are incorporated by reference herein.

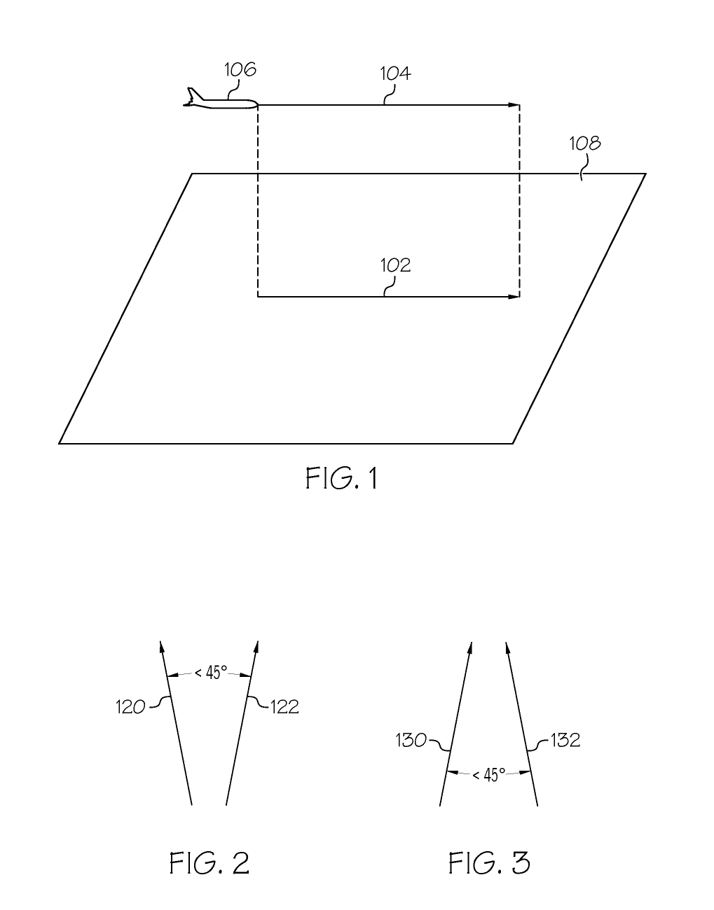

FIG. 1 is a diagram that illustrates track 102 associated with the flight path 104 of aircraft 106. Track 102 represents a projection of the flight path 104 onto a flat plane 108, which may correspond to the ground. Accordingly, track 102 will be the same whether the aircraft 106 maintains a fixed altitude, climbs, or descends while following flight path 104.

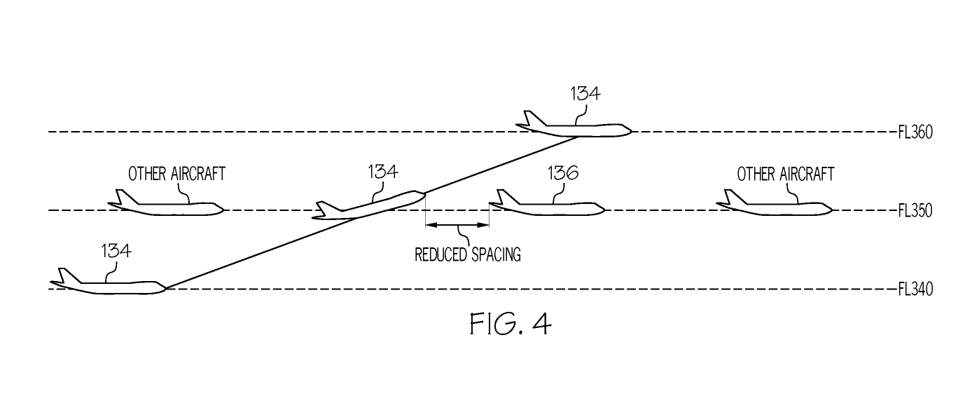

The RTCA/DO-312 document specifies that an in-trail procedure is a procedure that is employed by an aircraft that desires to change its flight level to a new flight level by climbing or descending in front or behind one or two, or between two same tracks, potentially blocking aircraft which are at an intervening flight level. A potentially blocking aircraft is an aircraft at an intervening flight level whose ADS-B data is available to the aircraft wishing to conduct an ITP maneuver. The host aircraft and any neighboring aircraft of interest (i.e., a potentially blocking aircraft) must be same track aircraft in order for an ITP flight level change to be requested. In this regard, “same track” means same direction tracks and intersecting tracks (or portions thereof) the angular difference of which is less than 45 degrees or more than 315 degrees. As an example, FIG. 2 is a diagram that illustrates the tracks 120 and 122 associated with two different aircraft. Even though the tracks 120/122 are divergent, they are considered to be in the same direction for purposes of the ITP because the angle between them is less than 45 degrees. As another example, FIG. 3 illustrates the tracks 130/132 associated with two different aircraft. Even though the tracks 130/132 are convergent, they are considered to be in the same direction for purposes of the ITP because the angle between them is less than 45 degrees.

As stated above, ITP is a protocol that can be followed when an aircraft seeks to change its flight level to a new flight level in the presence of potentially blocking aircraft located at an intervening flight level. For example, FIG. 4 is a vertical profile view illustrating a basic ITP procedure. In this case, aircraft 134 (i.e. the ITP aircraft) is seeking approval of an ITP procedure to climb from an initial flight level (FL340) through an intervening flight level (FL350) to a desired flight level (FL360). According to the RTCA/DO-312 document, ASTA-ITP was developed to enable either leading or following same track aircraft to perform a climb or descent to a requested flight level through an intervening flight level that might otherwise be disallowed when using standard separation minima. Moreover, the ITP specifies certain criteria that must be satisfied before the host aircraft can issue a request for ITP flight level change (such requests are issued to Air Traffic Control (ATC)).

RTCA/DO-312 defines reference aircraft as one or two similar track, potentially blocking aircraft no more than: 3,000 feet above or below the initial flight level, if vertical separation is 1,000 feet; or 2,000 feet above or below the initial flight level, if the vertical separation minima is 2,000 feet; with qualified ADS-B data that meets ITP speed/distance criteria and that will be identified to ATC by the ITP aircraft as part of the ITP clearance request. At least one of two ITP speed/distance criteria must be met: (1) if the ITP distance to a reference aircraft 136 is greater than or equal to 15 nautical miles, then the groundspeed differential between the two aircraft must be less than or equal to 20 knots; or (2) if the ITP distance to a reference aircraft 136 is greater than or equal to 20 nautical miles, then the groundspeed differential between the two aircraft must be less than or equal to 30 knots.

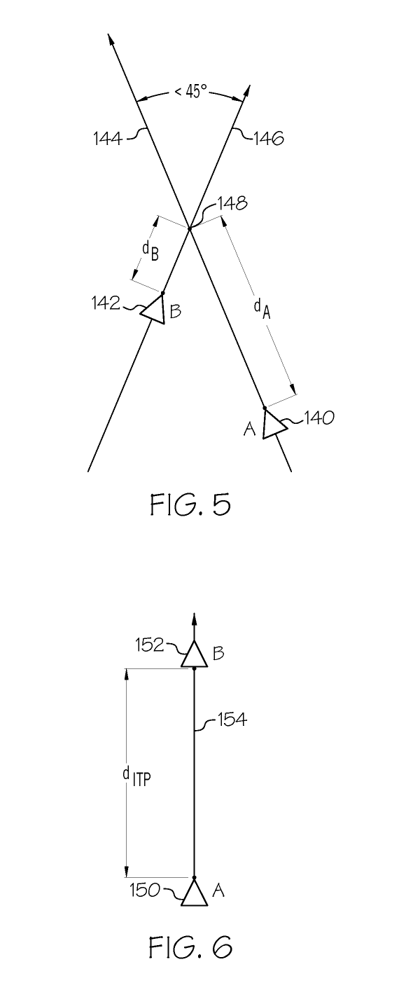

The ITP distance represents one appropriate measure of distance between the host aircraft and a nearby reference aircraft and potentially blocking, same track aircraft, which may be in front of or behind the host aircraft. Depending upon the particular embodiment, other distance metrics, distance measures, or relative spacing metrics could be used. For instance, the system could contemplate linear distance, time, aircraft acceleration, relative speed, closing rate, and/or other measureable or computable values that are dependent on the current geographic position, speed, acceleration, heading, attitude, or other operating status of the aircraft. The RTCA/DO-312 document defines the ITP distance as the distance between reference or potentially blocking aircraft and the ITP aircraft as defined by the difference in distance to a common point along each aircraft's track. In this regard, FIG. 5 is a diagram that illustrates the intersecting tracks associated with two different aircraft. In FIG. 5, one aircraft 140 is labeled “A” and another aircraft 142 is labeled “B”. The aircraft 140 has a corresponding track 144, and the aircraft 142 has a corresponding track 146 that intersects the track 144 at a point 148. Note that the aircraft 140/142 are considered to be in the same direction because the angle between the two tracks 144/146 is less than 45 degrees. In FIG. 5, the label “d_{A}” identifies the current distance between the aircraft 140 and the point 148, and the label “d_{B}” identifies the current distance between the aircraft 142 and the point 148. For this example, the ITP distance (d_{ITP}) is defined by the following expression: d_{ITO}=|d_{A}−d_{B}|.

As another example, FIG. 6 is a diagram that illustrates the overlapping tracks associated with two different aircraft. In FIG. 6, one aircraft 150 is labeled “A” and another aircraft 152 is labeled “B”. In this scenario, the two aircraft have a common or overlapping track 154. Consequently, the current distance between the two aircraft is also considered to be the ITP distance under these conditions. In FIG. 6, the label “d_{ITP}” indicates the current ITP distance between the aircraft 150 and the aircraft 152.

The systems and methods presented herein can be utilized to predict and display opportunities for ITP transitions. It is also contemplated that the proposed systems and methods will determine and display the time when a desired flight level and intermediate flight levels will become available.

In a first scenario, it is contemplated that a Flight Management System (FMS) will predict the optimum climb/descent altitudes. These are provided to a traffic computer or ITP display that determines the ITP transition possibilities for the predicted altitude based on received ADS-B IN data. The traffic computer, in turn, predicts different time sets and the corresponding candidate reference aircraft for the flight level changes proposed by the FMS. This prediction includes a consideration of the host aircraft's ground speed to predict the ITP transition times, which are displayed on the ITP display as will be shown and described hereinafter. In a second scenario, it is contemplated that a pilot selects a desired flight level change using the ITP display. The traffic computer then predicts a set of ITP opportunities available for transition to the desired flight level, which are displayed on the ITP display as in the first scenario.

In both scenarios, the traffic computer considers (1) all traffic present at the desired flight level and the closing or separating ground speed of the traffic intruders with respect to the host aircraft, and (2) the intent of the traffic from the traffic's ADS-B OUT transmissions; e.g. when the traffic is planning to change flight level and/or transition from the host aircraft's desired flight level. The traffic computer determines the time when an intermediate flight level will become available for transition. It considers the present position and ground speed difference of aircraft present in the intermediate flight level and determines when not more than two aircraft will be sufficiently separated to meet the criteria to be considered candidate reference aircraft. The traffic computer also validates that all other aircraft present in the intermediate flight level meet standard separation criteria with the host aircraft.

Thus, it is contemplated that the system and methods provided herein will determine, for each ITP opportunity: (1) a desired flight level, (2) the desired flight level availability time determined in accordance with the requirement of providing required standard separation with aircraft at the desired flight level, (3) the availability time of intermediate flight levels, (4) a maximum of two candidate reference aircraft with which the host aircraft can conduct an ITP transition for that flight level at the available time, and (5) the time duration of the ITP opportunity consisting of an ITP Start Time and an ITP End Time in minutes and seconds from the current time or in Greenwich Mean Time (Zulu Time). The time when the host aircraft can request an ITP transition and the candidate reference aircraft will be displayed.

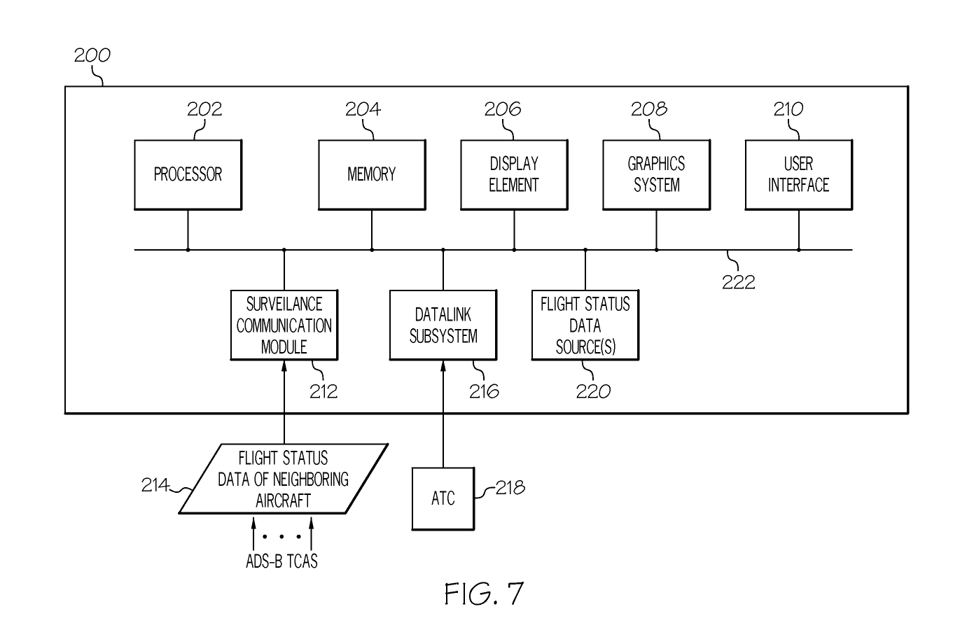

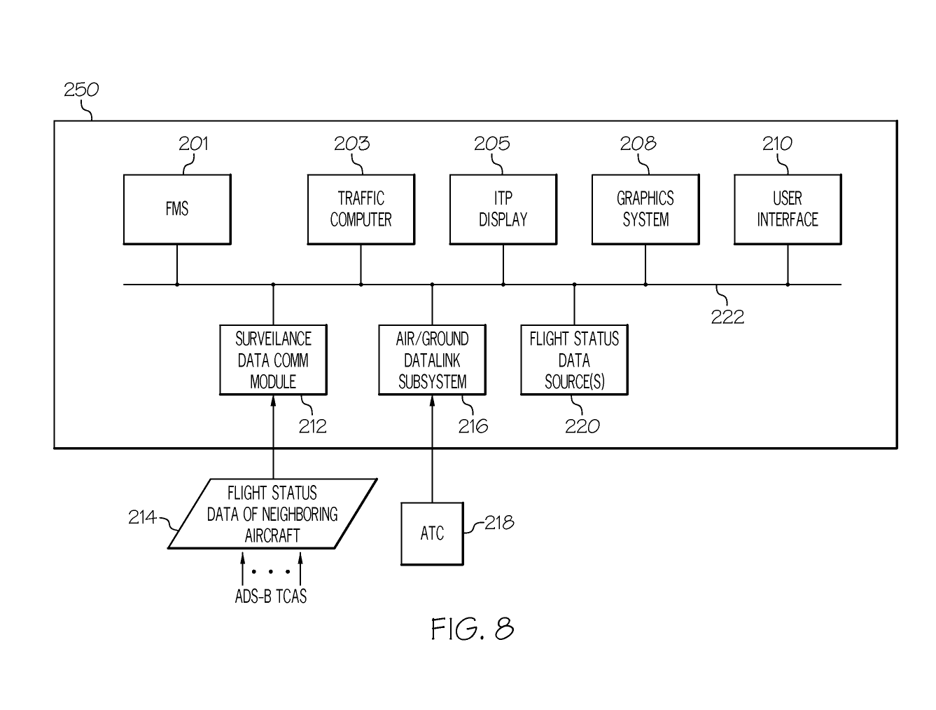

The above described displays can be generated using a suitably configured onboard system, such as a flight deck display system. More preferably, the display can be generated by the traffic computer that may receive data from the Flight Management System (FMS). In this regard, FIG. 7 is a schematic representation of an exemplary embodiment of a flight deck display system 200 that is suitable for use with a vehicle such as an aircraft. In exemplary embodiments, the display system 200 is located onboard the host aircraft, i.e., the various components and elements of the display system 200 reside within the host aircraft, are carried by the host aircraft, or are attached to the host aircraft. The illustrated embodiment of the display system 200 includes, without limitation: at least one processor 202; an appropriate amount of memory 204; a display element 206; a graphics system 208; a user interface 210; a surveillance data communication module 212; an air/ground data link subsystem 216; and at least one source of flight status data 222. These elements of the display system 200 may be coupled together by a suitable interconnection architecture 222 that accommodates data communication, the transmission of control or command signals, and/or the delivery of operating power within the display system 200. It should be understood that FIG. 7 is a simplified representation of the display system 200 that will be used for purposes of explanation and ease of description, and that FIG. 7 is not intended to limit the application or scope of the subject matter in any way. In practice, the display system 200 and the host aircraft will include other devices and components for providing additional functions and features, as will be appreciated in the art. Furthermore, although FIG. 7 depicts the display system 200 as a single unit, the individual elements and components of the display system 200 could be implemented in a distributed manner using any number of physically distinct pieces of hardware or equipment.

The processor 202 may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. As described in more detail below, the processor 202 obtains and processes current flight status data (of the host aircraft and one or more candidate reference aircraft and other neighboring aircraft) to determine ITP transition opportunities and to control the rendering of the ITP display in an appropriate manner.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 such that the processor 202 can read information from, and write information to, the memory 204. In the alternative, the memory 204 may be integral to the processor 202. As an example, the processor 202 and the memory 204 may reside in an ASIC. In practice, a functional or logical module/component of the display system 200 might be realized using program code that is maintained in the memory 204. For example, the graphics system 208, the surveillance data communication module 212, or the air/ground datalink subsystem 216 may have associated software program components that are stored in the memory 204. Moreover, the memory 204 can be used to store data utilized to support the operation of the display system 200, as will become apparent from the following description.

In an exemplary embodiment, the display element 206 is coupled to the graphics system 208. The graphics system 208 is coupled to the processor 202 such that the processor 202 and the graphics system 208 cooperate to display, render, or otherwise convey one or more graphical representations, synthetic displays, graphical icons, visual symbology, or images associated with operation of the host aircraft on the display element 206, as described in greater detail below. An embodiment of the display system 200 may utilize existing graphics processing techniques and technologies in conjunction with the graphics system 208. For example, the graphics system 208 may be suitably configured to support well known graphics technologies such as, without limitation, VGA, SVGA, UVGA, or the like.

In an exemplary embodiment, the display element 206 is realized as an electronic display configured to graphically display flight information or other data associated with operation of the host aircraft under control of the graphics system 208. In practice, the processor 202 and/or the graphics system 208 produces image rendering display commands that are received by the display element 206 for purposes of rendering the display. The display element 206 is usually located within a cockpit of the host aircraft. It will be appreciated that although FIG. 7 shows a single display element 206, in practice, additional display devices may be present onboard the host aircraft.

The illustrated embodiment of the display system 200 includes a user interface 210, which is suitably configured to receive input from a user (e.g., a pilot) or other crew member and, in response to the user input, supply appropriate command signals to the processor 202. The user interface 210 may be any one, or any combination, of various known user interface devices or technologies, including, but not limited to: a touchscreen, a cursor control device such as a mouse, a trackball, or joystick; a keyboard; buttons; switches; or knobs. Moreover, the user interface 210 may cooperate with the display element 206 and the graphics system 208 to provide a graphical user interface. Thus, a user can manipulate the user interface 210 by moving a cursor symbol rendered on the display element 206, and the user may use a keyboard to, among other things, input textual data. For example, the user could manipulate the user interface 210 to enter a desired or requested new flight level into the display system 200.

In an exemplary embodiment, the surveillance data communication module 212 is suitably configured to support data communication between the host aircraft and one or more remote systems. More specifically, the surveillance data communication module 212 is used to receive current flight status data 216 of other aircraft that are near the host aircraft. In particular embodiments, the data communication module 212 is implemented as an aircraft-to-aircraft surveillance data communication module that receives flight status data from an aircraft other than the host aircraft. For example, the surveillance data communication module 212 may be configured for compatibility with Automatic Dependent Surveillance-Broadcast (ADS-B) technology, with Traffic and Collision Avoidance System (TCAS) technology, and/or with similar technologies. Flight status data 220 may include, without limitation: airspeed data; fuel consumption; groundspeed data; altitude data; attitude data, including pitch data and roll data; yaw data; geographic position data, such as GPS data; time/date information; heading information; weather information; flight path data; track data; radar altitude data; geometric altitude data; wind speed data; wind direction data; etc. The display system 200 is suitably designed to process the flight status data 222 in the manner described in more detail herein.

The air/ground data link subsystem 216 enables the host aircraft to communicate with Air Traffic Control (ATC). In this regard, the air/ground data link subsystem 216 may be used to provide ATC data to the host aircraft and/or to send information from the host aircraft to ATC, preferably in compliance with known standards and specifications. Using the data link subsystem 216, the host aircraft can send ITP requests to ground based ATC stations and equipment. In turn, the host aircraft can receive ITP clearance or authorization from ATC (when appropriate) such that the pilot can initiate the requested flight level change.

In operation, the display system 200 is also configured to process the current flight status data for the host aircraft. In this regard, the sources of flight status data 220 generate, measure, and/or provide different types of data related to the operational status of the host aircraft, the environment in which the host aircraft is operating, flight parameters, and the like. In practice, the sources of flight status data 222 may be realized using line replaceable units (LRUs), transducers, accelerometers, instruments, sensors, and other well-known devices. The data provided by the sources of flight status data 220 may include, without limitation: airspeed data; groundspeed data; altitude data; attitude data, including pitch data and roll data; yaw data; geographic position data, such as GPS data; time/date information; heading information; weather information; flight path data; track data; radar altitude data; geometric altitude data; wind speed data; wind direction data; fuel consumption, etc. The display system 200 is suitably designed to process data obtained from the sources of flight status data 222 in the manner described in more detail herein. In particular, the display system 200 can use the flight status data of the host aircraft when rendering the ITP display.

As previously stated, in a first scenario the FMS provides the optimum altitude considering aircraft performance and weather conditions, and in a second scenario, the pilot selects the optimum altitude. FIG. 8 is a schematic representation of a further exemplary embodiment of a flight deck display system 250 wherein like reference numerals represent like elements. The illustrated embodiment again includes, without limitation, graphics system 208, user interface 210, surveillance data communications module 212, air/ground data link subsystem 216, and at least one source of flight status data source 220 as was the case in the embodiment shown in FIG. 7. However, this exemplary embodiment includes Flight Management System (FMS) 201, a traffic computer 203, and an ITP display 205, each coupled to interconnection architecture 222.

Flight Management System 201 is a specialized computer that automates a variety of in-flight tasks such as in-flight management of the flight plan. Using various sensors, the FMS determines the aircrafts position and guides the aircraft along its flight plan using its navigation database. Traffic Computer 203 processes surveillance data using ADS-B reports from the ADS-B receive function, and performs application specific processing. Surveillance reports, tasks, and any application specific information, e.g., alerts or guidance cues, are output to the traffic display function.

FMS 201 is integrated with the traffic computer 203 and may predict the optimum altitude taking weather conditions and host aircraft dynamics into account. The predicted flight level changes are provided to ITP display 205, which determines flight level availability considering traffic in that flight level and determines when standard separation at the desired flight level will exist with respect to the host aircraft. The ITP display also determines availability of intermediate flight levels for transition. Based on the availability of the desired flight level and intermediate flight levels, the ITP opportunity time sets may be determined. Graphics system 208 then generates symbology that is provided to the ITP display 205 and visually/textually represents the opportunity time sets.

As stated previously, during a long oceanic flight, a pilot may wish to change the cruise flight level (climb or descend) if the current flight level is not favorable in terms of, for example, fuel efficiency, weather, etc. If the above described ITP criteria is satisfied, the host aircraft sends an ITP request to air traffic control (ATC). ATC then determines if the reference aircraft has been approved to change speed or flight level or is about to reach a point at which a significant track change will occur. If any such change is predicted, the ITP request will be denied. The conventional ITP evaluation criteria does not take flight path changes of the reference aircraft into consideration. Thus, even if the host aircraft sends an ITP request, it will be rejected by ATC if the flight path of the reference aircraft is expected to change in the near future. This increases the number of invalid ITP requests sent to ATC and unnecessarily wastes the crew's time waiting for an ATC response.

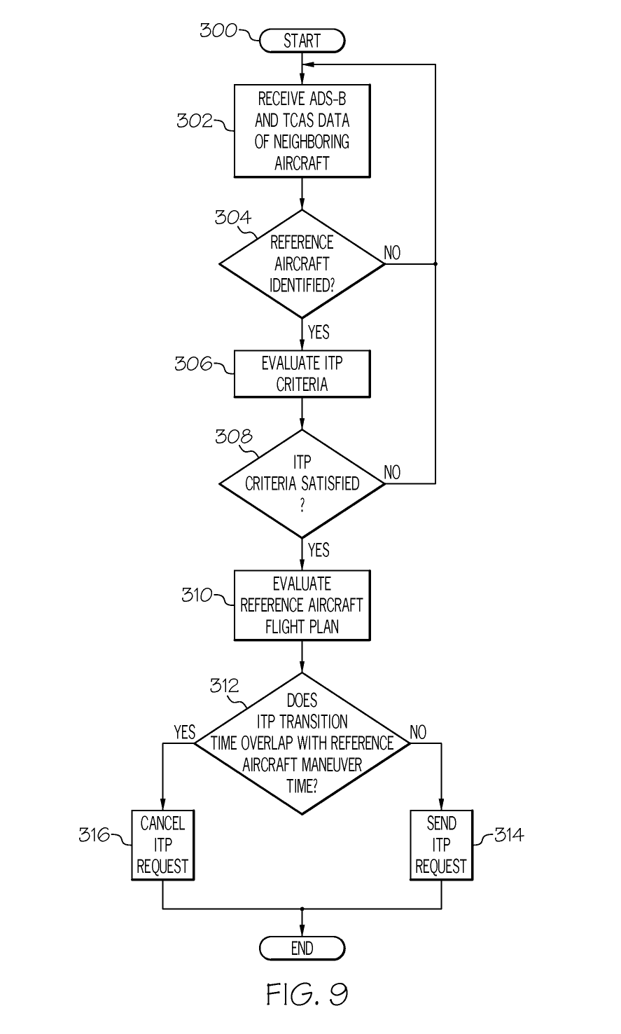

FIG. 9 is a flow chart illustrating a method 300 for reducing the in-trail procedure (ITP) rejection ratio by considering reference aircraft path change details while evaluating the ITP criteria in accordance with a first embodiment. The system determines if the ITP transition time of the host aircraft overlaps with the reference aircraft maneuver time as a result of the reference aircraft flight plan change. Is so, an ITP request is not sent to ATC resulting in a reduction in the number of invalid ITP requests. This, in turn reduces ATC workload and the workload of the flight crew.

Referring to FIG. 9, ADS-B and TCAS transmitted data (214 in FIG. 8) is received from nearby aircraft and provided to surveillance data communication module 212 (STEP 302). If a reference aircraft has been identified (STEP 304), the ITP criteria is evaluated (STEP 306). Aircraft meeting the ITP criteria and qualifying as reference aircraft are displayed on the ITP display (205 in FIG. 8); more specifically, on a Vertical Situation Display (VSD) portion of the display. If the ITP criteria is satisfied (STEP 308), the flight plan of the reference aircraft is evaluated (STEP 310) to determine whether or not the ITP transition time overlaps the reference aircraft maneuver time (STEP 312). If not, the ITP request is sent (STEP 314). If the ITP transition time overlaps the reference aircraft maneuver time (STEP 316), the ITP request is cancelled.

Thus, there has been provided a system and method that considers reference aircraft path change details while evaluating the ITP criteria. The ITP system would detect if the ITP transition time of the host aircraft overlaps with the reference aircraft maneuver time as a result of the reference aircraft flight plan change. In this case, an ITP request would not be sent to ATC. This results in a reduction in the number of invalid ITP requests, thereby reducing the workload of ATC personnel and the host aircraft flight crew. This promotes efficient trans-oceanic operations.

While at least one exemplary embodiment has been presented in the foregoing detailed description, it should be appreciated that a vast number of variations exist. For example, the techniques and methodologies presented here could also be deployed as part of a fully automated guidance system to allow the flight crew to monitor and visualize the execution of automated maneuvers. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for reducing the number of rejections of ITP requests, comprising preventing transmission of an ITP request if the ITP transmission time overlaps with a reference aircraft maneuver time.

2. The method of claim 1 further comprising receiving neighboring aircraft flight status data.

3. The method of claim 2 wherein the step of receiving neighboring aircraft flight status data comprises receiving ADS-B and TCAS data.

4. The method of claim 2 further comprising detecting the reference aircraft.

5. The method of claim 4 further comprising evaluating ITP criteria to determine that it is satisfied.

6. The method of claim 5 further comprising analyzing the flight plan of the reference aircraft to detect an upcoming reference aircraft maneuver.

7. The method of claim 6 further comprising analyzing the upcoming reference aircraft maneuver time to determine if it will overlap with the ITP transition time.

8. A method for reducing the ITP rejection ratio, comprising:
identifying a reference aircraft;
evaluating the ITP criteria associated with the reference aircraft; and
preventing transmission of an ITP request if the ITP transition time overlaps with a maneuver time of the reference aircraft.

9. The method of claim 8 further comprising receiving neighboring aircraft flight status data.

10. The method of claim 9 wherein the step of receiving neighboring aircraft flight status data comprises receiving ADS-B and TCAS data.

11. The method of claim 10 further comprising analyzing the flight plan of the reference aircraft to detect an upcoming reference aircraft maneuver.

12. A system onboard a host aircraft that reduces ITP request rejection, the system comprising:
a first source of neighboring flight status data;
a communication module coupled to the first source;
a second source of airspace data in the vicinity of the flight plan; and
a processor coupled to the data communication module and configured to (a) identify a reference aircraft; and (b) prevent transmission of an ITP request if a transmission time associated with the ITP request overlaps with a maneuver time of the reference.

13. The system of claim 12 further comprising a second source of host aircraft flight status data coupled to the processor.

14. The system of claim 12 further comprising a flight management system coupled to the first and second sources.

15. The system of claim 14 wherein the processor includes a traffic computer.

16. The system of claim 12 wherein the processor is further configured to detect a reference aircraft.

17. The system of claim 16 wherein the processor is further configured to evaluate ITP criteria to determine that it is satisfied.

18. The system of claim 17 wherein the processor is further configured to analyze the flight plan of the reference aircraft to detect an upcoming reference aircraft maneuver.
